(19) United States
(12) Patent Application Publication
(10) Pub. No.: US 2026/0322609 A1
(43) Pub. Date: Oct. 15, 2026

(54) Governance Layer Identity Binding, Policy Graph, and Global State Machine for Predictive Scoring, Safety Conditioned Orchestration, and Regulator Aligned Transparency.

(71) Applicant: DARIO CHANG, DORAL, FL (US)

(72) Inventor: DARIO CHANG, DORAL, FL (US)

(21) Appl. No.: 19/670,061

(22) Filed: May 7, 2026

Related U.S. Application Data
(63) Continuation-in-part of application No. 19/390,733, filed on Nov. 17, 2025.

(51) Int. Cl. H04L 9/32

(52) U.S. Cl. CPC H04L 9/3218; H04L 9/3236

(57) ABSTRACT

A governance system integrates an identity binding primitive, a governance graph primitive, and a global governance state machine to unify predictive scoring, biological-behavioral safety, compliance proofs, provenance, and marketplace enforcement. An identity binding primitive generates a canonical identity binding record referencing governance artifacts and computes an identity digest embedded across tokens, proofs, and safety envelopes. A governance graph primitive evaluates nodes representing governance states and edges representing policy conditions using predictive scoring data, safety tier data, and compliance proof data. A global governance state machine determines whether transitions between governance states are permitted and generates state envelopes containing the identity digest and evidence of transition requirements. The system supports regulator-visible artifacts, temporal and jurisdictional policy overlays, anomaly-triggered escalation, and ledger-anchored auditability, enabling unified, transparent, and verifiable governance across heterogeneous AI-mediated workflows

### CROSS-REFERENCE TO RELATED APPLICATIONS

This application is a Continuation-in-Part of U.S. patent application Ser. No. 19/390,733, filed Nov. 17, 2025; U.S. patent application Ser. No. 19/397,884, filed Nov. 22, 2025; and U.S. patent application Ser. No. 19/654,645, filed Apr. 22, 2026, the entirety of each of which is incorporated herein by reference.

### FIELD OF THE INVENTION

The invention relates to governance-layer architectures for AI-mediated systems. More specifically, the invention introduces identity binding, policy graph, and global state machine primitives that unify predictive scoring, biological-behavioral safety, compliance proofs, provenance, marketplace enforcement, and regulator-aligned transparency.

### BACKGROUND

Existing governance systems treat predictive scoring, biological-behavioral safety, compliance proofs, provenance tokens, workflow tokens, settlement receipts, and regulator disclosures as disconnected modules. This fragmentation results in inconsistent enforcement, unverifiable state transitions, incomplete audit trails, policy drift, identity ambiguity, and regulator blind spots.

### Need for the Invention

There is no canonical identity anchor binding governance artifacts, no graph-structured policy engine linking safety, scoring, and compliance, and no unified global state machine defining allowed transitions, required proofs, and regulator-visible artifacts. The present invention closes these gaps.

### Conceptual Lineage Statement

In certain embodiments, aspects of the present invention are conceptually consistent with governance-layer primitives first articulated by the inventor in U.S. Patent Application Publication No. 2004/0133469, filed in 2003, which described early forms of transparent decision modules and governance-oriented computational structures. The present application does not claim priority to the 2003 filing, but acknowledges its conceptual lineage as part of the inventor's long-standing development of governance-layer architectures.

### SECTION 1—SUMMARY OF THE INVENTION

### Overview

The invention introduces three governance-layer primitives:
Identity binding primitive (IBP) for canonical identity anchoring.
Governance Graph Primitive (GGP) for graph-structured policy evaluation.
Global Governance State Machine (GSM) for unified state transition enforcement.

### Architectural Integration

These primitives unify predictive scoring (IPS), biological-behavioral safety (BBFV/SGOK), compliance proofs (ZKP/TEE), provenance, marketplace enforcement, and regulator transparency into a single governance operating system.

### SECTION 2—IDENTITY BINDING PRIMITIVE (IBP)

### Identity Binding Record (IBR)

The system defines an Identity Binding Record comprising:
ib_id
subject_ref
token_refs[ ]
attestation_refs[ ]
consent_refs[ ]
governance_tags[ ]

### Canonicalization and Digest

The IBR is canonicalized and hashed to produce an identity digest:

[ib_digest =H(\text{canonicalize}(IBR))]

### Embedding of Identity Digest

The ib_digest is embedded into:
IPS tokens
BBFV safety envelopes
provenance tokens
workflow tokens
settlement receipts ensuring cryptographic identity continuity across the governance OS.

### Ledger Anchoring

In some embodiments, IBRs are anchored to a tamper-evident ledger, enabling regulator verification of identity continuity.

### SECTION 3—GOVERNANCE GRAPH PRIMITIVE (GGP)

### Governance Graph Structure

A Governance Graph comprises:

### Nodes

IPS scores and confidence intervals
BBFV safety tiers
proofs (ZKP, TEE)
provenance tokens
workflow tokens
settlement states
regulator obligations

### Edges

policy rules
dependencies
escalation paths
disclosure requirements
safety constraints

### Node and Edge Representation

Each node and edge includes:
conditions
actions
jurisdiction
policy_version
signature

### Graph Evaluation Engine

The GGP engine evaluates the graph to determine:
allowed actions
forbidden actions
required proofs
required disclosures
escalation triggers

### Illustrative Non-Limiting Math

A policy edge may be represented as:

[e=(u, v, \phi, \alpha)]
where:
(u)=source node
(v)=target node
(\phi)=predicate over IPS, BBFV, proofs
(\alpha)=action set

### SECTION 4—GLOBAL GOVERNANCE STATE MACHINE (GSM)

### Global State Descriptor (GSD)

The GSM defines:
entity_type
state_space[ ]
transition_rules[ ]

### Transition Rule Structure

Each transition rule includes:
from_state, to_state
preconditions
required_artifacts
regulator_obligations
failure_actions

### State Envelopes

The GSM produces state envelopes containing:
entity_ref
from_state, to_state
ib_digest
proof_digest
governance_graph_version
timestamp, signature

### Illustrative Non-Limiting Pseudocode

def transition(entity, from_state, to_state):
   if not check_preconditions(entity, from_state, to_state):
      return reject(“preconditions_failed”)
   if not verify_artifacts(entity, from_state, to_state):
   return reject(“artifact_missing”)
envelope=create_state_envelope(entity, from_state, to_state)
anchor(envelope)
return accept(envelope)

### SECTION 5—INTEGRATION WITH EXISTING PRIMITIVES

### Integration with IPS

IBP binds IPS tokens; GGP uses IPS thresholds; GSM enforces IPS-driven transitions.

### Integration With BBFV/SGOK

IBP binds safety envelopes; GGP uses safety tiers; GSM enforces safety transitions.

### Integration With Proof Registry

IBP binds proofs; GGP requires proofs; GSM enforces proof-conditioned transitions.

### Integration with Marketplace Enforcement

IBP binds workflow tokens; GGP defines settlement rules; GSM enforces settlement transitions.

### SECTION 6—EXPERIMENTAL EMBODIMENTS (NEW MATTER)

### A. Identity Embodiments

Multi-modal identity fusion
Quantum-resistant identity binding
Federated identity binding

### B. Governance Graph Embodiments

Temporal policy graphs
Multi-jurisdiction overlays
Adversarial policy graphs

### C. Global State Machine Embodiments

Multi-asset state machines
Probabilistic state machines

### D. Mathematical Embodiments

Category-theoretic governance
Topological safety envelopes
Information-theoretic identity binding

### E. Implementation Embodiments

Neuromorphic governance
Quantum governance
Synthetic data governance

### SECTION 7—ADVANTAGES

### F. Multi-Agent Governance Embodiments

### Multi-Agent Governance

In some embodiments, the governance system manages interactions among multiple agents, each associated with an identity binding record and governed by a shared or partially shared governance graph. Multi-agent governance transitions may include joint preconditions, inter-agent dependencies, conflict-resolution policies, or cooperative action requirements. The global governance state machine may evaluate multi-agent transition rules that incorporate aggregated predictive scoring vectors, combined safety envelopes, or multi-party compliance proofs.

### G. Model-level Governance Embodiments

### Model Governance

In some embodiments, the governed entity comprises a machine-learning model, model version, or model checkpoint. Governance states may include training, evaluation, deployment, rollback, suspension, or deprecation. Transitions between model governance states may require safety proofs, provenance attestations, lineage records, or regulator-visible artifacts. The governance graph may include edges representing model-specific constraints such as dataset provenance requirements, safety tier thresholds, or performance-drift limits.

### H. Dataset-Level Governance Embodiments

### Dataset Governance

In some embodiments, datasets or dataset partitions are governed entities within the global governance state machine. Dataset transitions may include ingestion, labeling, augmentation, sanitization, partitioning, or deletion. Preconditions for dataset transitions may include privacy proofs, bias-detection proofs, or provenance attestations. Dataset governance may further include temporal constraints, jurisdiction-specific data-handling rules, or regulator-mandated retention policies.

### I. Incentive-Aligned Governance Embodiments

### Incentive-aligned Governance

In some embodiments, governance transitions incorporate incentive mechanisms such as rewards, penalties, staking, or slashing conditions. Incentive-aligned governance may require that entities maintain valid safety envelopes, compliance proofs, or provenance chains to avoid penalties or to qualify for rewards. The governance graph may include edges that encode incentive curves, risk-adjusted penalties, or performance-based rewards.

### J. Regulator-Triggered Governance Embodiments

### Regulator-Triggered Governance

In some embodiments, a regulator or oversight authority may trigger governance transitions, impose additional preconditions, or require supplemental proofs or disclosures. Regulator-triggered transitions may include emergency suspension, mandatory audit, forced rollback, or conditional reinstatement. The global governance state machine may incorporate regulator-defined transition rules or override conditions.

### K. Governance Simulation Embodiments

### Governance Simulation

In some embodiments, the governance system includes a simulation environment for evaluating governance transitions under adversarial, stochastic, or regulator-defined scenarios. The simulation environment may generate synthetic governance trajectories, adversarial stress tests, or regulator-in-the-loop evaluations. Simulation outputs may be used to update safety envelopes, adjust policy edges, or refine transition rules within the global governance state machine.

### Advantages

The invention:
unifies all governance primitives
creates a standard-like governance OS
enables regulator-aligned transparency
provides identity continuity
enforces safety and compliance
supports multi-agent orchestration
provides complete auditability
supports future CIP expansion

### SECTION 8—SCOPE

### Scope

The invention is not limited to any specific identity modality, policy graph structure, state machine topology, proof mechanism, biological modality, or marketplace architecture. All examples are illustrative and non-limiting.

END SPEC

1. A governance system comprising:
a. an identity binding primitive configured to generate an identity binding record comprising references to governance artifacts associated with an entity and to compute an identity digest based on a canonical representation of the identity binding record;
b. a governance graph primitive comprising a plurality of nodes representing governance states and a plurality of edges representing policy conditions and associated actions, the governance graph primitive configured to evaluate the nodes and edges based on governance inputs comprising predictive scoring data, safety tier data, and compliance proof data; and
c. a global governance state machine configured to determine, based on outputs of the governance graph primitive, whether a transition between a first governance state and a second governance state is permitted, and to generate a state envelope comprising the identity digest and evidence of satisfaction of transition requirements.

2. A method for governance of an entity, the method comprising:
a. generating an identity binding record comprising references to governance artifacts associated with the entity;
b. canonicalizing the identity binding record and computing an identity digest;
c. evaluating a governance graph comprising nodes representing governance states and edges representing policy conditions, the evaluation based on predictive scoring data, safety tier data, and compliance proof data;
d. determining, via a global governance state machine, whether a transition between a first governance state and a second governance state is permitted based on the evaluation; and
e. generating a state envelope comprising the identity digest and evidence of satisfaction of transition requirements.

3. A non-transitory computer-readable medium storing instructions that, when executed by one or more processors, cause the processors to perform operations comprising:
a. generating an identity binding record and computing an identity digest;
b. evaluating a governance graph comprising nodes and edges representing governance conditions;
c. determining, via a global governance state machine, whether a governance state transition is permitted; and
d. generating a state envelope comprising the identity digest and evidence of satisfaction of transition requirements.

4. The system of claim 1, wherein the identity binding record comprises references to predictive scoring tokens, safety envelopes, provenance tokens, workflow tokens, or compliance proofs.

5. The system of claim 1, wherein the identity digest is computed using a cryptographic hash of a canonicalized representation of the identity binding record.

6. The system of claim 1, wherein the identity binding primitive is further configured to anchor the identity digest to a tamper-evident ledger.

7. The system of claim 1, wherein the identity binding record further
comprises one or more consent references associated with the governance of the entity.

8. The system of claim 1, wherein the governance graph primitive evaluates edges comprising predicates over predictive scoring values, safety tiers, compliance proofs, or combinations thereof.

9. The system of claim 1, wherein the governance graph primitive further comprises jurisdiction-specific policy overlays.

10. The system of claim 1, wherein the governance graph primitive is configured to generate escalation actions based on detection of anomalous or adversarial conditions.

11. The system of claim 1, wherein the governance graph primitive comprises
temporal policy edges that vary based on time-dependent conditions.

12. The system of claim 1, wherein the global governance state machine defines a plurality of governance states comprising at least one of: listed, unlisted, active, suspended, restricted, settled, or quarantined.

13. The system of claim 1, wherein the global governance state machine requires verification of a proof digest prior to permitting a governance state transition.

14. The system of claim 1, wherein the global governance state machine generates regulator-visible artifacts based on the governance state transition.

15. The system of claim 1, wherein the global governance state machine is
configured to perform rollback or quarantine actions when transition requirements are not satisfied.

16. The system of claim 1, wherein the predictive scoring data comprises a predictive scoring vector generated by a predictive scoring engine.

17. The system of claim 1, wherein the safety tier data comprises a biological-behavioral fusion vector and a safety gating determination.

18. The system of claim 1, wherein the compliance proof data comprises at least one of: a zero-knowledge proof, a trusted execution environment attestation, or a verifier receipt.

19. The system of claim 1, wherein the state envelope comprises a governance graph version identifier.

20. The system of claim 1, wherein the state envelope is anchored to a tamper-evident ledger to enable reconstruction of a governance state trajectory.
